(19) United States
(12) Patent Application Publication
(10) Pub. No.: US 2024/0265456 A1
(43) Pub. Date: Aug. 8, 2024

(54) DISCOVERING VALUES FOR METRICS OF ENTITIES FROM NON-STANDARDIZED DATASETS

(71) Applicant: Forge Global, Inc., San Francisco, CA (US)

(72) Inventors: Brian Coyle, New York, NY (US); Alejandro Ortiz, Chicago, IL (US); Alice Giomi, San Francisco, CA (US)

(21) Appl. No.: 18/435,875

(22) Filed: Feb. 7, 2024

Related U.S. Application Data
(60) Provisional application No. 63/483,586, filed on Feb. 7, 2023.

(51) Int. Cl. G06Q 40/06

(52) U.S. Cl. CPC G06Q 40/06

(57) ABSTRACT

The technology can recommend a value for an equity metric of a private entity. The technology can configure a list to include keys for fund portfolios of fund management services that issue reports. The technology selects keys to search a repository for reports that each include equity data for private entities. The technology retrieves the most recent reports for matching fund portfolios and generates data tables that include the equity data extracted from the reports. The technology finds target data of a target private entity in the data table based on fuzzy logic and uses a machine-learned model to predict a value per quantity metric for the target private entity. The system can cause a device to present a control element that can be triggered to initiate a transaction with the private entity based on the predicted value per quantity metric.

### CROSS-REFERENCE TO RELATED APPLICATIONS

This application claims the benefit of priority to U.S. Provisional Application No. 63/483,586, filed Feb. 7, 2023, which is incorporated by reference herein in its entirety.

### TECHNICAL FIELD

This disclosure relates to engines for predicting values of metrics.

### BACKGROUND

A mutual fund is a collection of investment securities that has been acquired in accordance with a particular strategy. The mutual fund is managed by a manager who performs the selling of held securities or purchasing of new securities to try to keep the mutual fund in alignment with its investment strategy. Mutual funds are regulated by the Securities and Exchange Commission (SEC). For example, the SEC requires that the mutual funds report their holdings (list of securities) on a quarterly basis. One purpose of the reports is to offer transparency into funds. Specifically, these reports allow investors of the funds to glean whether the funds comply with the investment strategy. The form for filing such reports is presently known as an N-PORT. Thus, a registered management investment company uses Form N-PORT to file periodic (e.g., monthly, quarterly) reports of fund information and to file information quarterly about its portfolio holdings. At least some of the reports are made publicly available as a time snapshot of performance.

### BRIEF DESCRIPTION OF THE DRAWINGS

Detailed descriptions of implementations of the present invention will be described and explained through the use of the accompanying drawings.

FIG. 1 is a system diagram that illustrates components for predicting metrics based on periodically reported, non-standard data from different sources.

FIG. 2 is a flowchart that illustrates a fund discovery process performed by a system of the disclosed technology.

FIG. 3 is a flowchart that illustrates a process for predicting values of an equity metric of a target entity.

FIG. 4 is a flowchart that illustrates a process for matching data items from nonstandard datasets of reported filings to predict values for an equity metric of a target entity.

FIGS. 5A through 5C illustrate views of user interfaces administered by the disclosed technology for subscribers of a platform.

FIG. 6 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology includes a system configured to predict unknown values for assets based on reported data posted on a central repository. The reported data are posted to the repository by different sources that are aggregators of the assets. In one example, the repository can include an entirety of Securities and Exchange Commission (SEC) databases of reported data. The reported data includes standard data for public entities and non-standard data for non-public (e.g., private) entities. The standard data includes fixed values that are determined irrespective of the aggregators of assets, while the non-standard data varies depending on their aggregators. In other words, the aggregators of assets for non-public entities are the sources of variability for the non-standard data.

The fixed values for assets are assigned to public entities and are held by different aggregators but have the same fixed value. In contrast, the variable values for assets are determined by aggregators, known to the issuers of the assets, but not uniform across aggregators that hold the same assets. The data for the variable values are used to train a machine-learned engine that is subsequently used to predict values, which can be used to acquire assets from non-public entities at values that are comparable given the data found in the reports.

The disclosed technology improves over prior systems with timely processing of reported data that expansively covers private issuers to predict data that harmonizes the non-standard data. In one example, the machine-learned engine can predict “marks” for non-public companies based on recently reported data of mutual funds holdings. Because of the nature of filings and SEC regulations that restrict what mutual funds (e.g., aggregators) can hold in portfolios, these marks are unknown and difficult to aggregate on a regular and timely basis.

In one example, the system can automatically check daily for reports that include target data that is then extracted and transformed that same day and used to predict marks for private companies. In another example, the system can capture and check for a new fund as soon as that fund starts filing a report with the SEC. Hence, the datapoints have the most up-to-date information for issuers of interest. The system can perform a process for issuer name matching and filtering that solves the problem of a lack of any recognized or standardized identification process for private entities. In another example, a computer-implemented process can predict marks for non-public entities based on quarterly reported Form NPORT-P filings of mutual funds holdings. The repository receives and stores data in reports communicated over one or more computer networks from various fund manager computer systems. The system can screen the reports for target data that is extracted and processed for predicting marks for private entities.

The reports include data for funds, such as equity metric values for public companies. In particular, the reports include metric values for quantities and prices for securities held by the fund manager for companies. The reports can also include other data for non-public companies that represent equity holdings. However, the data for the non-public companies may not specify a price per equity unit that is publicly known. That is, although the price per equity value of a public company is publicly known, the same metrics data is not publicly constant for each non-public company. As a result, the metric values for non-public companies are unknown because they are not defined at any point in time except at a point in time of a particular transaction. Therefore, any buyer of an equity share of a private company lacks a way to determine a fair market value (FMV).

The holdings of equities for non-public companies that are held by multiple fund managers are reported periodically to a repository along with the holdings for public companies. Reports of different fund entities reported at different times are communicated over communications networks to the common repository. For example, monthly reports of a first fund entity are issued and communicated over a computer network to a repository and other reports of a second fund entity are issued and communicated monthly over a computer network to the repository.

The repository publishes some of the reported data, which aggregate multiple marks for various entities. Consequently, the metric values for public companies shown in the reported data include quantities per equity shares, such as the price per quantity paid for shares. The metric values for the public companies are known independently from the reports. In contrast, the reports of different fund managers can indicate values for equity shares of non-public companies, where the values are unknown independently from the reports. As a result, the value of an equity share for a private company is unknown to a buyer because the value is undefined at any point in time. Thus, the reports include marks for public shares, which equate a value per share and can express aggregate values of private equity holdings. The disclosed technology thus processes data in the reports to predict marks for private holdings.

In one example, the Form N-PORT is used by a registered management investment company (also referred to herein as a “fund manager service” or “service”) to file reports of monthly portfolio holdings. The SEC can use the information provided in the reports in its regulatory, enforcement, examination, disclosure review, inspection, and policymaking roles. Fund managers must report information quarterly about their portfolios and each of their portfolio holdings as of the last business day, or last calendar day, of each month. More specifically, the SEC requires reports on Form N-PORT for each month in a fiscal quarter to be filed with the SEC not later than 60 days after the end of that fiscal quarter (as opposed to filing each monthly report no later than 30 days after the end of each month). Persons who respond to the collection of information contained in this form are not required to respond unless the form displays a currently valid OMB control number (SEC 2940 (8/22)) after the end of such fiscal quarter. The reports must disclose portfolio information as calculated by the fund for the reporting period's ending net asset value. The technology can also extract and transform data as soon as it becomes available on posted reports. That is, as soon as a mutual fund file reports a new valuation for a specific issuer, the technology can capture that valuation datapoint and make it available on a platform to facilitate transactions for assets from the same issuer. That valuation datapoint could be the most up-to-date data datapoint for that issuer that is available.

The disclosed technology can identify, extract, and transform datapoints from one or more reports, aggregate the datapoints, and process or train the aggregated data with the machine-learned engine to predict a metric for equity shares of non-public companies, which are not included as marks in the reports. In one example, an autonomous program (e.g., bot) on the internet or another network can interact with a network portal of the repository to target specific funds that include data about specific non-public companies. With that process, the technology can cover every fund that has filed a Form NPORT-P report and holds equities for companies of interest. Hence, the machine-learned engine is configured to discover marks of non-public issuers, which are comparatively fewer than marks for public issuers. Further, the amount of total funds (i.e., total value) for non-public issuers is comparatively less than the total value for public issuers. For example, the marks and/or total value for non-public funds can be 0.1%-0.5% compared to the marks and/or total value for public funds.

In one example, the computer-implemented process has two parts. Specifically, once a new report for a target fund is identified, fund data is collected in a first process and provided to a second process that predicts a mark for a non-public equity share based in part on the data included in the new report. The technology checks to find the latest-filed report for a particular fund with an automated process that compares a filing date of an identified report against the date of the last-processed report. That most recent filing is pulled for further processing. When a more recent report is not found, the process can still automatically identify, extract, and aggregate useful data from the filing.

The technology retrieves the most recent reports for aggregators that have key identifiers matching those on the list and generates data tables that include the equity metric data extracted from the reports. In particular, the data extracted from the reports of different funds can be aggregated in tabular format and stored in a database, which can be updated periodically (e.g., quarterly) and/or as new filings are posted. As such, the technology can extract datapoints and instantaneously train the machine-learned engine to accurately predict marks shortly after a report has been submitted. The extraction process can be run on a daily basis to constantly add new data from new fund reports. The metrics for non-public companies are predicted based on data derived from the database. For example, the technology can configure a list to include key identifiers for fund profiles (e.g., funds) and/or aggregators (e.g., fund managers) that issue reports including equity metrics. The technology selects key identifiers to search the repository for reports that each include distinct value per quantity metrics for public entities but not private entities, though they include data regarding equities held for private entities.

The non-public issuers are not required to have key identifiers, which are used to identify and extract data for public issuers. Consequently, the reports do not include key identifiers for non-public issuers, which are used to identify and extract data for public issuers. Instead, the data for non-public issuers included in reports include arbitrary data in fields that would otherwise include key identifiers. To address this deficiency, the system uses a regular expression (regex) and/or fuzzy algorithms to filter data for non-public issuers in reports that match those of interest on a list.

A regex is a sequence of characters that specifies a match pattern in text. For example, the patterns are used by string-searching algorithms for “find” or “find and replace” operations on strings or for input validation. The regex algorithm thus takes a pattern (or filter) that describes a set of strings that matches the pattern. In other words, the regex algorithm accepts a certain set of strings and rejects the rest. Using a regex algorithm, the system finds patterns in reports that match data for non-public issuers.

The technology can also find data of a target private entity in reports based on fuzzy logic and derive a value per quantity metric for the target private entity. The technology can report to users of the predicted values for non-public issuers. The predicted data can be used to educate and inform users before buying or selling certain assets (e.g., securities), which are available for exchange on a marketplace of a platform administered by the system. The platform can be accessed on an electronic device that presents control elements, which can be triggered to initiate a transaction based on the predicted value per quantity metric. That is, the predicted price per share for a private company can be presented for a user to initiate buying a quantity of equity shares for the private company at or near the predicted price.

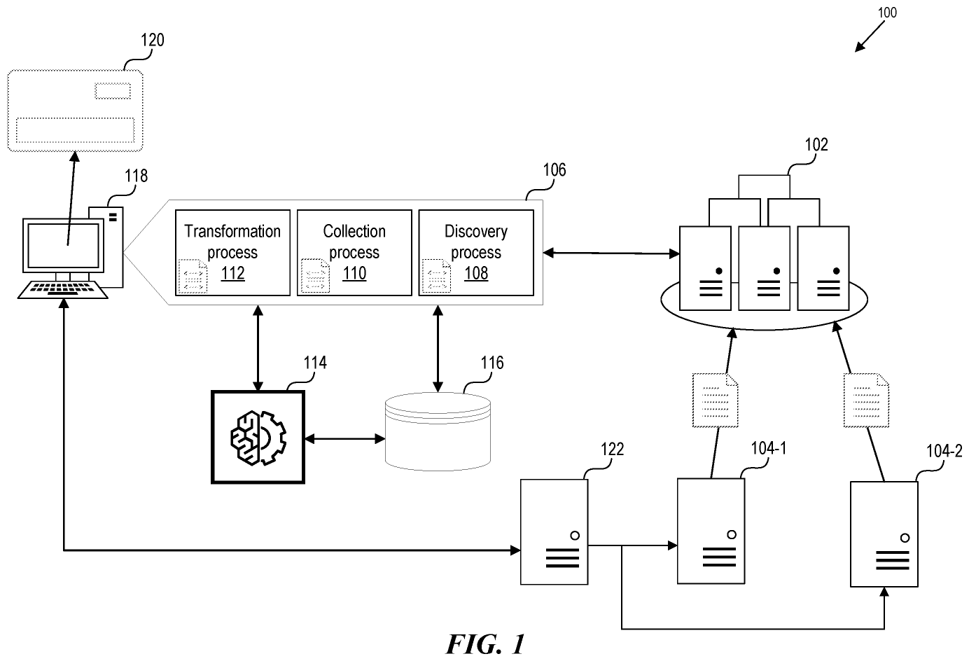

FIG. 1 is a system diagram that illustrates components of a system 100 configured for predicting metrics based on periodically reported data from different aggregator sources. As shown, the system includes a repository 102 that receives reports from different sources 104-1 and 104-2 (referred to collectively as “sources 104” and individually as “source 104”). The repository can include a singular storage location for all data from the sources 104. This model is utilized to create a single source of truth, providing significant benefits to visibility, collaboration, and consistency within data management. For example, a repository can include one or more servers in a datacenter that are connected to the different sources 104 over one or more communications networks. In another example, the repository is a distributed network of storage systems that store the reports provided by the sources 104.

An example of the report includes Form N-PORT, which is an SEC filing that requires registered investment companies to submit details of their portfolio holdings on a quarterly basis, along with monthly breakdowns. An example of a report includes one or more data that have a standardized structure for processing by the repository 102. The repository 102 can make reports available to the public or other parties through an online interface. The interface can include a network portal that is administered by the repository 102 for access by subscribers or the general public. For example, the repository 102 can administer a web portal that is accessible by users in the public to access information included in the reports provided by the sources 104.

The sources 104 can include one or more servers administered by a fund manager. In one example, the sources 104 aggregate information about equity holdings of public and non-public holdings that are in the reports sent to the repository 102. In that example, the sources 104 are administered by fund managers. The sources 104-1 and 104-2 are controlled independently to upload the reports on a periodic basis. For example, the reports can be uploaded to the repository 102 weekly, monthly, or quarterly from the sources 104. Once received, the reports can be parsed into data that are searchable and available to the public. In one example, only some of the reports are made available to the public. For example, the repository 102 can receive reports from each source 104 on a monthly basis but only make quarterly reports available to the public.

The data that are made available to the public can include the reports or portions of the reports. The reports and/or issuers of assets are each associated with a key identifier that is used to map the issuer of assets included in the report. The key identifier is unique for each source of a respective report. For example, a fund report from a fund manager includes a key identifier that uniquely identifies the fund and/or fund manager. Thus, all reports from the same fund manager include the same key identifier. The fund reports can also be timestamped to indicate when the report was generated or sent to the repository 102. As such, the most recent report for a particular fund can be identified. For example, the machine-learned engine can compare the timestamp of a report for the same fund manager to a report that was previously retrieved from the repository 102.

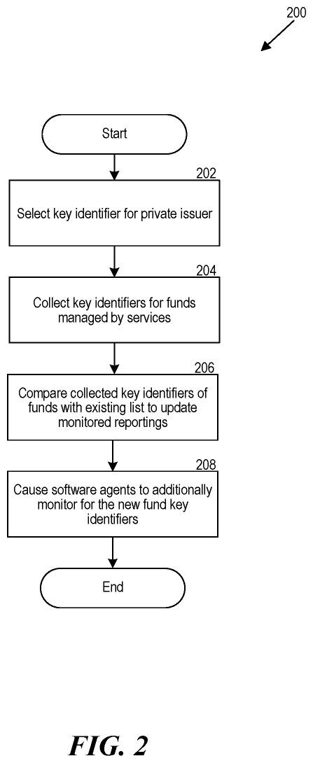

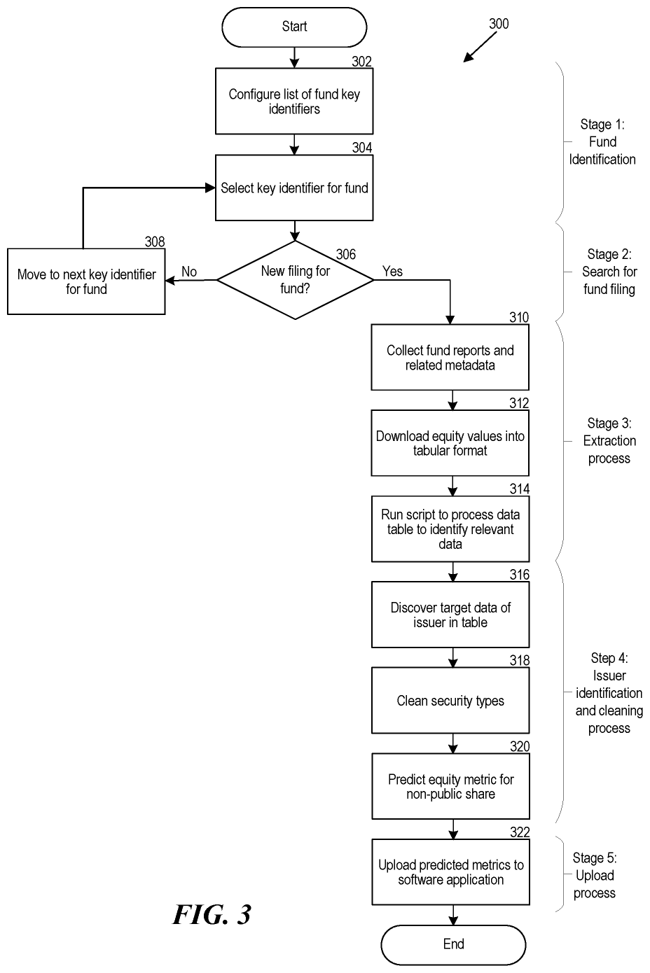

The system 100 includes one or more scripts 106 configured to discover, collect, and transform the data retrieved from the repository 102 into data used to predict unknown metric values. The data included in the reports undergo a discovery process 108, collection process 110, and transformation process 112 to produce metric data. The discovery process 108, collection process 110, and transformation process 112 are described later in greater detail in FIGS. 2 and 3. In some embodiments, a machine-learned engine 114 processes target data from the reports to predict the metric values for non-public entities. The target data can include training data that is stored in a storage device 116 for use to improve subsequent predictions of metrics data.

The “machine-learned” engine can include one or more models, where a model refers to a construct that is trained using training data to make predictions or provide probabilities for new data items (e.g., prices for private shares), regardless of whether the new data items were included in the training data. For example, training data for supervised learning can include items with various parameters and an assigned classification. A new data item can have parameters that a model can use to assign a classification to the new data item. As another example, a model can be a probability distribution resulting from the analysis of training data, such as a likelihood of an n-gram occurring in a given language based on an analysis of a large corpus from that language. Examples of models include neural networks, support vector machines, decision trees, Parzen windows, Bayes, clustering, reinforcement learning, probability distributions, decision trees, decision tree forests, and others. Models can be configured for various situations, data types, sources, and output formats.

In some implementations, the machine-learned engine 114 can include a neural network with multiple input nodes that obtain data of the reports and/or outputs of the scripts executed to perform the discovery process 108, collection process 110, and transformation process 112. As such, the input nodes can correspond to functions that receive the input and produce results. These results can be provided to one or more levels of intermediate nodes that each produce further results based on a combination of lower-level node results. A weighting factor can be applied to the output of each node before the result is passed to the next layer node. At a final layer (“the output layer”), one or more nodes can produce a value classifying the input that, once the model is trained, can be used to predict unknown metric values. In some implementations, such neural networks, known as deep neural networks, can have multiple layers of intermediate nodes with different configurations, can include a combination of models that receive different parts of the input and/or input from other parts of the deep neural network, or are convolutions-partially using output from previous iterations of applying the model as further input to produce results for the current input.

The machine-learned engine 114 can be trained with supervised learning, where the training data includes the processed or raw data from the reports as input and a desired output, such as the metric values of successful transactions for private shares. A representation of metrics can be provided to a model for a predicted metric value. Output from the model can be compared to the desired output for that metric value, and based on the comparison, the model can be modified, such as by changing weights between nodes of the neural network or parameters of the functions used at each node in the neural network (e.g., applying a loss function). After applying each of the data in the training data and modifying the model in this manner, the model can be trained to predict new metric values.

A user device such as a desktop computer 118, laptop computer, handheld mobile device, or other device with a display can present a user interface 120 that includes actionable data or a control element that enables an actionable process based on the predicted metrics data. For example, the actionable data can include the predicted metrics data (e.g., price for equity shares of a private company) that is presented on the user interface 120. A user can offer the predicted price to a private issuer 122 of the equity shares. An example of the control element can include a button, slider, or another graphical element. For example, a user can adjust one slider to a desired quantity of private shares and adjust another slider to a proposed price where that slider has a range relative to the predicted price (e.g., +/−10%). As such, the user can perform a transaction directly with an issuer of private equities (e.g., source 104-1).

In one example, the marks that are reported are presented in a graph on an interface to compare mark prices with other price indicators such as indication of interest (101) prices, previous transaction prices, and funding round prices. A user can then make an informed decision to decide to trade an asset of an issuer on the marketplace platform. The predicted data can be offered in multiple forms. For example, the data can be presented on the marketplace for users to view a sample of the latest price data from fund managers. In another example, the data platform presents a full and detailed view of historical data and a graph of price indicators. In yet another example, an application programming interface (API) can provide users with a full dataset (e.g., more than 20,000 mark prices for private issuers from more than 300 mutual funds). The API thus enables users to perform their own analysis of the reported dataset.

As such, the disclosed technology can provide users with a new price indicator that brings transparency to the private market and is from a direct source of investors into private issuers. The technology can also reduce a message-to-execution ratio corresponding to a number of messages required to execute an order instruction for assets of a private issuer. That is, fewer electronic messages are necessary to identify metric values to complete execution of a transaction for buying private shares because there is a higher likelihood that the predicted price for the private shares is accepted by the seller to complete a transaction. In other words, the communications between buyers and sellers are reduced, which reduces utilization of network resources and congestion on communications networks.

FIG. 2 is a flowchart that illustrates a fund discovery process 200 performed by a system of the disclosed technology. The process 200 can be performed regularly and frequently to ensure that recent data is extracted to consistently cover any new fund that was recently created and is holding an issuer of interest or that just added an issuer of interest to its holdings. The process 200 can update a list of regex for fund portfolios that hold equities for non-public companies of interest. The portfolios are managed by one or more fund management services that aggregate the assets for the portfolios. That is, the management services are aggregators managing portfolios that aggregate equity shares for different entities into a fund. An example of a fund management service includes an issuer of mutual funds or exchange-traded funds (ETFs). Each fund management service has a unique identifier that distinguishes that service from other services that manage other mutual funds.

Each fund management service can issue a variety of different funds that each have unique key identifiers. A key identifier can include a string of characters or another combination of elements that uniquely identifies a particular service or portfolio from others. For example, a particular fund can be identified based on a combination of a key identifier for the service and a key identifier of a portfolio managed by the service. Examples of the different entities include a public entity (e.g., public company) and a non-public entity (e.g., private company). A mutual fund portfolio can include equity metrics for public companies, such as the quantity and value per quantity of equity shares that are held by the issuer of the fund. The mutual fund can hold equities for private companies as well, and the management service can report the holdings in the mutual fund even though a public price per share equity metric for a non-public entity is undefined.

At 202, key identifiers are selected for non-public entities. For example, the key identifiers for private companies of interest are identified to predict their metric values (e.g., price per equity share) based on reports issued to a repository from management services that hold equities in the non-public entities. For example, key identifiers for two services that hold equities for a particular private company of interest are identified. Another key identifier for a different service that holds an equity interest for another private company of interest is also identified. As such, the key identifiers for the different private issuers are selected.

At 204, key identifiers for portfolios that include equities for the non-public entities of interest are collected. In one example, a script uses the key identifiers for the non-public companies to search websites of various management services to identify key identifiers for portfolios that include equities for the non-public companies of interest. In one example, the script is executed by a software agent that collects key identifiers for the management services and key identifiers for their portfolios that include equities for the non-public companies. For example, key identifiers that identify mutual funds can be collected from the management services' websites or a third-party service that maintains the key identifiers. In one example, the key identifiers are unique for particular funds managed by different services. For example, a fund management service can manage 10 funds, where only three include equities for the non-public companies of interest. The key identifiers that are collected can be for the three funds that include equities for the non-public companies of interest. The key identifiers for the remaining funds that do not include equities for the non-public companies of interest are precluded.

At 206, a script compares the collected key identifiers against a preexisting list of key identifiers that are used to monitor the repository for reports of metric data. For example, the key identifiers are compared against the preexisting list to determine whether the new key identifier is missing from the list and should be added or whether the new key identifier is incorrectly recorded in the list. In one example, the list is stored in a database and maps key identifiers to fund names.

At 208, the updated list of key identifiers is communicated to the software agents that are configured to monitor the repository for reports of portfolios identified based on the key identifiers. Thus, the collected key identifiers for funds and/or fund management services are compared with key identifiers that are currently known and used by the software agents to search the repository for reports.

FIG. 3 is a flowchart that illustrates a process 300 for predicting an equity metric of a target entity (e.g., a private company). The process 300 can be performed by one or more servers of a computer system coupled over one or more networks (e.g., the internet) to a repository. In one example, a non-transitory, computer-readable storage medium stores instructions, which, when executed by at least one data processor of a system, cause the system to perform the functions described in the process 300. The first stage of the process 300 starts at 302 to perform fund identification.

At 302, the system configures a list to include key identifiers for fund portfolios of fund management services, as described with respect to FIG. 2. The portfolios include equity metrics or related data for two types of entities (e.g., public and non-public entities). The list can be processed by a script executed by software agents that search for reports stored at the repository. In one example, a bot executes the script to search the repository for reports issued by management services of the funds that include equity information of interest for non-public entities. For example, the bot can input the key identifier for the fund and/or its fund manager into a search field of a web portal of the repository to search for matching keys associated with metrics data included in recently posted reports.

At 304, a particular key identifier for a particular portfolio is selected from the list. The selected key identifier is included in a query that is submitted to a field of the repository to search for relevant reports. The repository stores multiple and distinct reports for the different funds that were communicated over one or more computer networks (e.g., the internet) from servers of the multiple fund management services. The reports include distinct value per quantity metrics for respective public entities as well as equity data for non-public entities of interest but preclude unique value per quantity metrics for the non-public entities. The reports that are stored at the repository were communicated over the one or more computer networks from the servers of the multiple management services to the repository on a periodic basis (e.g., monthly), and potentially, only some of those reports are made available to the public (e.g., only the quarterly reports). The second stage of the process 300 starts at 306 to search for fund filings.

At 306, the repository is monitored based on key identifiers on the list to search for particular reports generated by particular management services of portfolios matching particular keys on the list. For example, the bot can generate a query string that is input to a search field of a website of the repository. The query is used to search for reports from management services that manage fund portfolios having matching keys. The bot can recursively select a next key identifier on the list of keys to monitor for a report for a next portfolio, and so on, at step 308. As such, one or more key identifiers are included in one or more queries to search the repository for reports issued by one or more management services. The third stage of the process 300 starts at 310 to perform an extraction process.

At 310, the system collects the fund reports and related metadata that allows for identifying the most recent reports for particular portfolios. The entire portfolios or portions thereof are retrieved from the repository. The reports can be identified by searching the key identifiers and comparing the timestamps of the reports to identify the most recent reports from among a group of reports sent by the same management service or by comparing a timestamp of a report to a current date or the last known date of a report previously retrieved from the repository.

At 312, a data table is generated and/or populated with equity metrics data for the non-public entities, which were extracted from the reports retrieved from the repository. The data table aggregates equity metrics data of the non-public entities as extracted from the reports. The data table can also aggregate data for public entities extracted from the reports in addition to the data from the non-public entities. In one example, an XML file is generated and populated with the data extracted from the reports. The system can also run scripts to process the table file (e.g., XML file) and determine where to pick relevant data from among all the data in the reports at 314. In one example, a machine-learned engine can be trained to identify relevant portions of reports. The fourth stage of the process 300 starts at 316 to perform an issuer identification and cleaning process to transform the extracted data for predicting equity metrics.

At 316, scripts are executed to discover target data of non-public entities of interest in the data table based on, for example, a fuzzy logic matching process. For example, the names used to identify issuers of private shares are noisy between filings of different aggregators. For example, the name for shares of a private issuer can include or omit characters, such that string matching is not possible. This can result because the same company can have a public name that differs from its legal name, and different aggregators can use one name or the other. In fact, a completely random name that is unrecognizable to humans could be used to identify the associated issuer.

The fuzzy logic matching process can find similar but not identical entries indicative of the non-public entity of interest. In one example, a key identifier for the target non-public entity is vectorized and compared to other vectorized keys in the data to identify the target data. For example, text in the data table is matched based on the particular vector key that is given to a particular non-public entity. The matching process can use data other than names of an issuer to identify the issuer. For example, the matching process can use data indicative of the country of the issuer, an exchange rate associated with the issuer, or any number of multiple dimensions to identify a target issuer.

At 318, security features are optionally cleared from the target data of the target non-public entity in the data table. In one example, clearing the security features includes performing text and pattern recognition to determine a security type and remove unnecessary information from the target data of the non-public entity of interest.

At 320, a value per quantity metric is predicted for the non-public entity of interest based on the target data extracted from the reports. In one example, the value per quantity metric for the non-public entity of interest is predicted by processing equity metrics data of the non-public entity with the machine-learned engine including a model that is generated and trained based on data extracted from the reports, as described earlier. The output of the machine-learned engine includes the predicted value per quantity metric of the non-public entity. In another example, a value of the non-public entity is determined from one or more reports of multiple funds issued by one or more management services. A total unit equity value for the non-public entity held by each aggregator is analyzed to predict or estimate a value based on the reports from the different aggregators. For example, the value can be averaged for the same mutual fund or multiple mutual funds. As such, the predicted equity metric values are estimated by dividing the total values by the total unit values in one or more reports issued by one or more aggregators. In another example, datapoints for a unit equity value are weighted differently for different aggregators. The outputs can include a range of unit equity values or a specific value. The fifth stage of the process 300 starts at 322 to perform an upload process.

At 322, the system causes one or more electronic devices to present actionable information or an actionable control element based on the predicted metric data for the non-public entity, as described earlier. In one example, execution of the actionable control element causes communication of a message configured to initiate a transaction for one or more equity units of the non-public entity at the predicted value per quantity metric. Additional analytics that provide insights of the target non-public entity can also be derived and presented to a user on an electronic device.

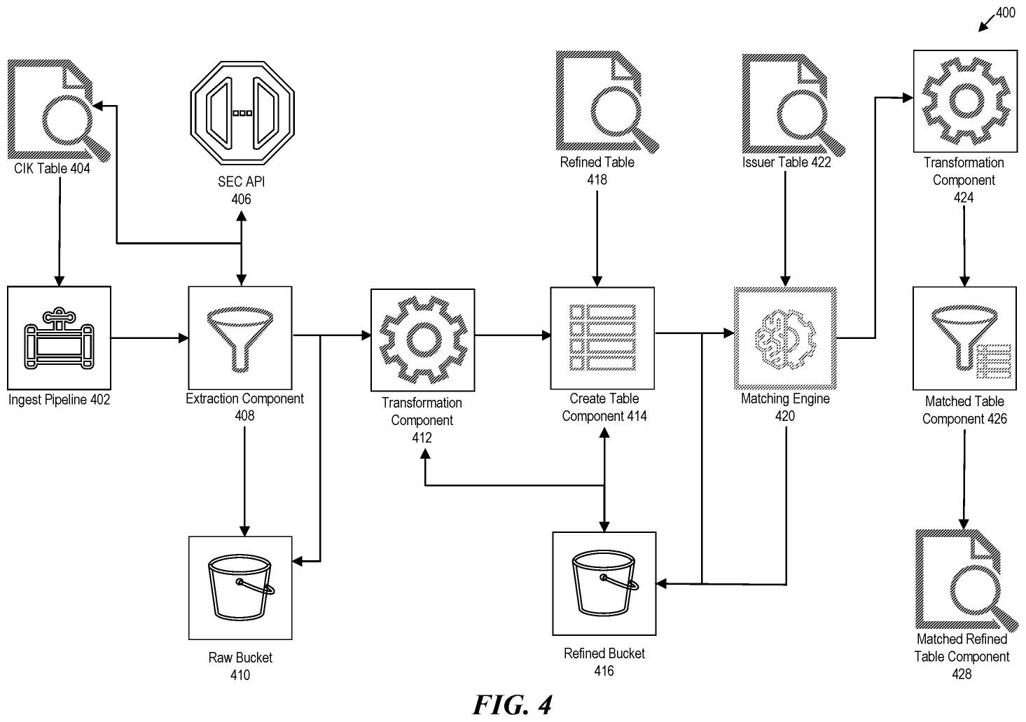

FIG. 4 is a flowchart that illustrates a process 400 performed by computing resources of a platform for matching data items from non-standard datasets extracted from reported filings. The extracted data items are used to predict or estimate values for an equity metric of target entities (e.g., non-public issuers) that are available to subscribers of the platform. The process 400 can operate iteratively to update or refine values for the target issuers that are available to subscribers. For example, the process 400 can operate to iteratively aggregate data items for target issuers obtained over time and/or for data items for the target issuers that are obtained from additional or different aggregators. As such, the process 400 can aggregate data for the same issuers from the same sources and/or new sources.

The process 400 can increase the performance and computational efficiency of the platform by pulling only data items of target issuers for pre-processing (e.g., sorting, filtering, and extracting). Rather than discard data items of non-target entities in reported filings, the platform stores the raw data in repositories. As such, the platform can pull raw data items from the repositories when issuers are added as new targets for the process 400. That is, the raw data can be processed later to extract data items for the new targets. In addition, the platform can process the raw data for newly discerned identifiers of target issuers to update or finetune values for target issuers. For example, the platform can discover a string that identifies a target issuer that was not considered in prior iterations of the process 400. As such, the process 400 reduces processing by curating data items for target issuers while keeping raw data available for expanding target issuers and/or for expanding identifiers for existing target issuers.

An ingest pipeline 402 is a source of datasets that are processed for grouping data items of matching target entities to predict or estimate values for metrics of those entities. In one example, the datasets include information of equities for public and non-public companies and identities of issuers of the equities. A central index key (CIK) table 404 can store key identifiers of aggregators that hold assets of issuers and related information. The content of the CIK table 404 can be retrieved from a repository such as the SEC's computer systems to identify entities (e.g., corporations, individuals) who have filed disclosures with the SEC. The information from the CIK table 404, including the key identifiers, is fed to the ingest pipeline 402. Moreover, information about issuers (e.g., non-private companies) is stored at the issuer table 422 and fed to the ingest pipeline 402.

The SEC API 406 is operable to search the SEC EDGAR archive repository for recently disclosed SEC filings and to access related corporate documents. In particular, the SEC API 406 can find and analyze audited and unaudited financial statements from 10-Q and 10-K filings, extract text content from EDGAR documents and convert filings into PDF, Word, or Excel file types having different formats, and stream the SEC filings data in real time. The CIK table 404 can thus store key identifiers and related data items that have been extracted from the streamed SEC filings data, where the key identifiers are of entities that have filed disclosures with the SEC (e.g., mutual fund holders).

The ingest pipeline 402 and the SEC API 406 feed datasets to the extraction component 408, which functions to extract target data items from reports as soon as they are available from the SEC. The extraction component 408 can store raw datasets obtained from the ingest pipeline 402 and the SEC API 406 at a raw bucket 410 repository and feed the extracted target data to the transformation component 412. In one example, the ingest pipeline 402 can check daily whether an aggregator (e.g., mutual fund) has filed a new N-PORT filing. When a new filing is discovered, code executed by the extraction component 408 creates an accessible direct URL leading to the filing's XML format. The extraction component 408 then downloads and stores each filing as an XML file as well as metadata of the filing. Raw XML files are created and store the extracted data as “[name]/<YYYY-MM-DD>/<cik>/data/<accession-number>.xml.” In one example, each filing is stored in the database to re-scan for any new issuer added to the platform.

The transformation component 412 can transform extracted data from a filing into a readable and queryable table format. The transformation component 412 can also perform a cleaning process of the extracted data items. The process can include fixing or removing incorrect, corrupted, incorrectly formatted, duplicate, or incomplete data items. When combining multiple data items from different sources or sources collected at different times, there are many opportunities for data to be duplicated or mislabeled, which the transformation component 412 can remedy. In one example, the transformation component 412 can convert the extracted data items into a parquet data format that contains fields of interest. The parquet data is in a format that is a column-oriented data file format designed for efficient data storage and retrieval.

The create table component 414 creates a refined table 418, which can store all data points from filings. The transformation component 412 can add metadata (e.g., fund name, filing date, filing number) to the raw bucket 410 and/or refined bucket 416 for future use. The extracted fields from the data items can be inserted as data records into tables created by the create table component 414. Hence, the create table component 414 stores the parquet dataset containing values for fields of interest. The transformation component 412 can use Python libraries to read and/or extract data directly from the extraction component 408 and/or from the raw bucket 410. In one example, the Python libraries include Pandas, which is used for working with datasets. It can have functions for analyzing, cleaning, exploring, and manipulating the extracted data.

The refined bucket 416 stores the transformed data in parquet format. The transformed data is easier to query compared to the pre-transformed data and can thus be used to quickly discover unknown values of metrics. The platform can read the data from the files and create the table that gets updated with every new filing that is retrieved. The matching process also uses the refined bucket 416 to read data items and extract matching data items. The refined table 418 provides a table view to query the data, analyze the data, or download the data (e.g., using AWS Athena to read the table). In one example, the table contains all the records from the filings and all the fields to be reused for a variety of purposes, if necessary.

The matching engine 420 retrieves data from the create table component 414 and the issuer table 422. The issuer table 422 includes one or more tables that store information about non-public issuers identified in the filings. For example, the issuer table 422 can aggregate identifiers and values for metrics of non-private issuers collected over time and used later to discover and update values for metrics of their equities. The issuer table 422 is synchronized to track records that attempted to match with known issuers and backfills for new issuers. Thus, for example, the matching engine 420 can match data items extracted from the create table component 414, from the refined table 418 through the table component 414, and/or from the refined bucket 416 based on data of known issuers stored in the issuer table 422. Adding a new issuer to the issuer table 422 triggers a process to search the refined table 418 using the matching engine 420, which then adds the identified data to the matched table 426 via the transformation component 424. The matching engine 420 spawns multiple glue jobs to process issuers in parallel. A glue job encapsulates a script that connects to source data, processes it, and then writes it to a data target. Typically, a job runs extract, transform, and load (ETL) scripts. Jobs can also run general-purpose Python scripts (Python shell jobs.) In one example, the matching engine 420 executes regex or fuzzy logic algorithms to match data of the same issuer obtained from the create table component 414, the refined table 418, and the refined bucket 416 with the issuer table 422. The matching engine 420 can use parallel multiprocessing to reduce the run times of jobs. In one example, the matching engine 420 performs string matching on millions of datapoints. To reduce the overall processing time, the matching engine 420 can run multiple instances of the same job at the same time.

In one example, the matching engine includes a regex processor that translates a regular expression into an internal representation that can be executed and matched against a string representing the text being searched. One possible approach is to construct a nondeterministic finite automaton (NFA), which is then made deterministic, and the resulting deterministic finite automaton (DFA) is run on the target text string to recognize substrings that match the regular expression. As such, the regex processor can match a regular expression for a target non-private issuer from the issuer table 422 with data items pulled by the matching engine 420 from the create table component 414 or other sources. The regex algorithm can be used in the string pre-processing before a matching job is performed. The regular expressions can be used to extract the exact equity type for certain issuers and/or for certain equity types. In another example, the platform uses a RapidFuzz algorithm, which is a fast-string matching library for Python and C++. The fast-string matching library uses Levenshtein distance to find the closest similarity between two strings to identify data items or the same issuer.

The following example shows string transformation and matching. The platform matches data for one issuer (using multiple aliases and attributes) against, for example, 12 million records of different names and aliases used by different funds for the same issuer. The fuzzy nature of the algorithm addresses the issue that marks for private issuers are not identified by a specific identifier number and are sparse in an aggregator's portfolio.

| Nport Issuer Name | Nport Security Name |
|---|---|
| American Well Corporation | AMERICAN WELL CORP COMMON STOCK USD.01 |
| American Well Corp | AMERICAN WELL CORP COMMON STOCK USD.01 |
| CARBON INC | CARBON INC SER D PC PERP PP |
| CANVA INC SERIES A | CANVA INC SERIES A 0.00000000 |
| CANVA SERIES A-4/PFD/ | CANVA SERIES A-4/PREFERRED/0.00000000 |
| CANVA INC | CANVA INC PP (PHYSICAL) (NOT LISTED OR TRADING) |
| CELONIS SE SERIES D/PFD | CELONIS SE SERIES D/PREFERRED/0.00000000 |
| Centrexion Therapeutics Corp. | Centrexion Therapeutics Corp.-Private Placement |
| BigCommerce Holdings, Inc. | BigCommerce Holdings, Inc., Series 1 |
| AIRBNB INC-CLASS A | AIRBNB INC-CLASS A 0.00000000 |
| 1661, INC. (D.B.A. GOAT) PREFERRED SERIES A-5/ | 1661, INC. (D.B.A. GOAT) PREFERRED SERIES A-5/ |
| CARBON INC | CARBON INC SER D PC PERP PP |

[symbol]

| Company | Internal Ticker | Legal Name | Security |
|---|---|---|---|
| American W [symbol] | american-well | American Well Corporation | Common |
| American W [symbol] | american-well | American Well Corporation | Common |
| Carbon | carbon | Carbon, Inc. | Series D |
| Canva | canva | Canva Pty Ltd | Series A |
| Canva | canva | Canva Pty Ltd | Series A-4 |
| Canva | canva | Canva Pty Ltd | Common |
| Celonis | celonis | Celonis GmbH | Series D/Preferred/ |
| Centrexion T [symbol] | centrexion-therapeutic [symbol] | Centrexion Therapeutics Cor [symbol] | Common |
| BigCommerc [symbol] | bigcommerce | BigCommerce Holdings, Inc. | Series 1 |
| Airbnb | airbnb | Airbnb, Inc. | Common |
| GOAT | goat | 1661, Inc. | Series A-5 |
| Carbon3D, In [symbol] | carbon3d-inc | 0 | Series D |

[symbol]

indicates data missing or illegible when filed

As shown above, data items of the same issuer are retrieved from various reports. After the matching process has been completed, the issuer table 422 updates or creates a table with data for only issuers of interest (e.g., target issuers). That table can be used later by the matching engine 420 to search and aggregate data items for the same issuer.

The process 400 optionally includes another transformation component 424 coupled to the matching engine 420 to perform a transformation job that refines matched data before making the data available for consumption by subscribers. For example, the transformation component 424 can assign internal issuer names, derive price marks, and clean up security names prior to publishing data to subscribers.

The matched table component 426 stores the data of identified matches. The matched refined table component 428 is the final component that serves to load the outputs of the platform for subscriber consumption. The outputs can include predictions or estimates for values of metrics of equities of non-public issuers. The discovered values can be estimated based on, for example, numerical calculations such as the average metric value for equities of a particular issuer.

The process 400 can generate estimates for price marks of private securities despite there being no recognized or standardized way to refer to or identify private issuers in mutual fund filings (e.g., no standard identifier). The process 400 can also disambiguate variable references to common private issuers, which solves a problem that mutual funds use different ways to refer to or identify a private security. The process 400 can estimate a price mark for an issuer of interest as soon as the fund files the N-PORT with the SEC.

In one implementation, the process 400 analyzes a dataset of over 18 million unique datapoints for private issuers. For example, the process 400 can analyze over 31,000 filings of over 2,500 mutual funds, over 4 or 5 years. The process identifies over 600,000 individual securities of targeted private issuers from over 12 million individual securities being held by the mutual funds. The 600,000 individual securities are used for performing a pricing analysis and other historical data analysis. Identifying the necessary securities is a non-trivial process as currently mutual funds are required to limit an aggregate of their illiquid assets to no more than 15%, of which typically only a few are allocated to private issuer securities, depending on the fund type. The platform aggregates price marks, but also different fields (attributes) related to each private issuer. An estimate of the total amount of mutual fund filings with the SEC is currently about 10,594 mutual funds. As such, if there are about 1,160 securities per filing, with four filings per mutual fund each year, that amounts to 49,183,523 different data points (securities) every year. If the scope of targeted private issuers includes over 2,600 names, the process 400 can identify any security related to one of these issuers within the 50 million datapoints in the SEC.

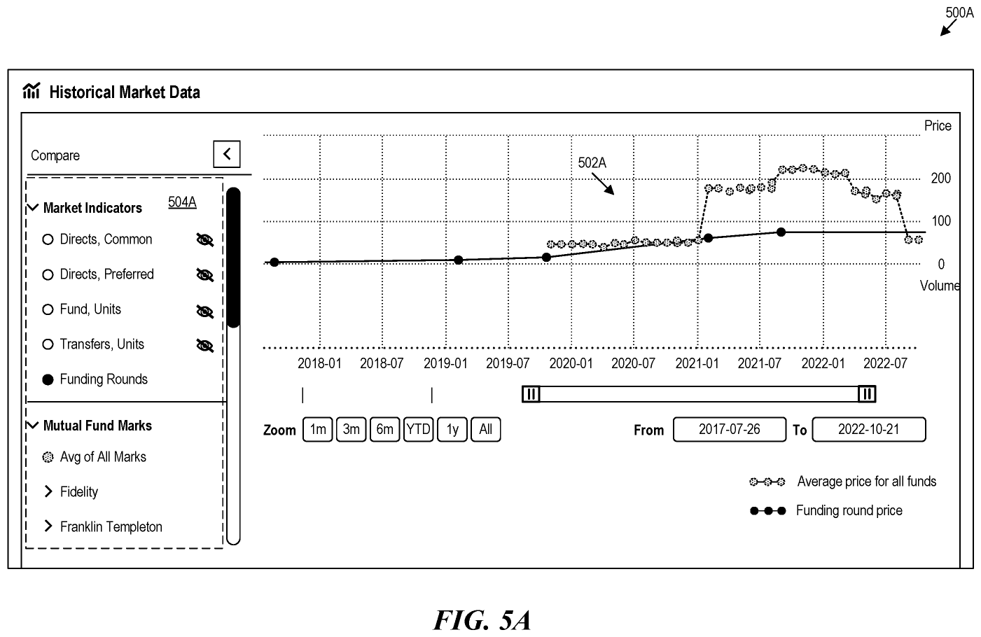

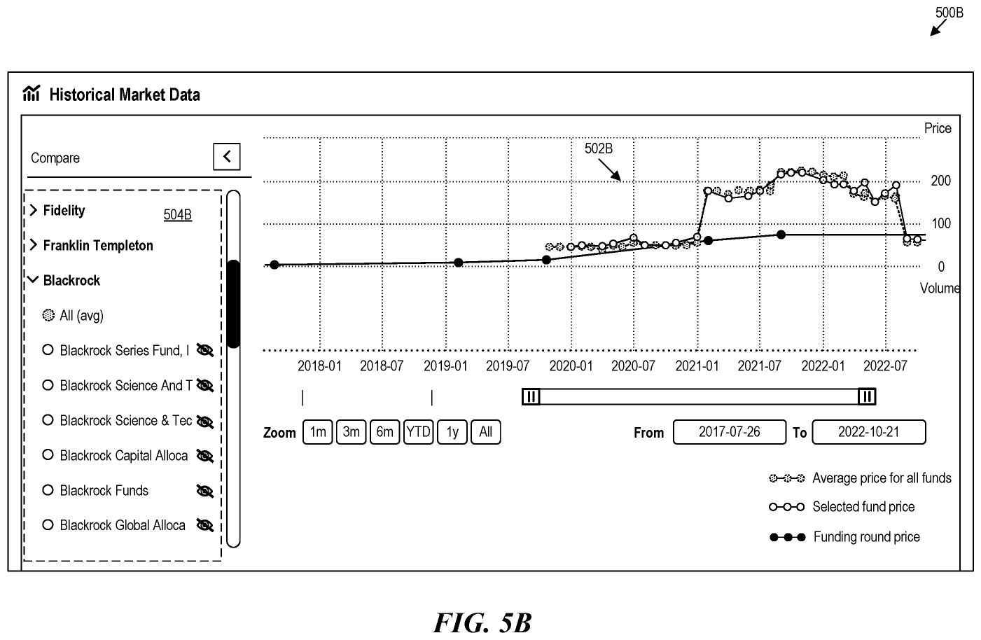

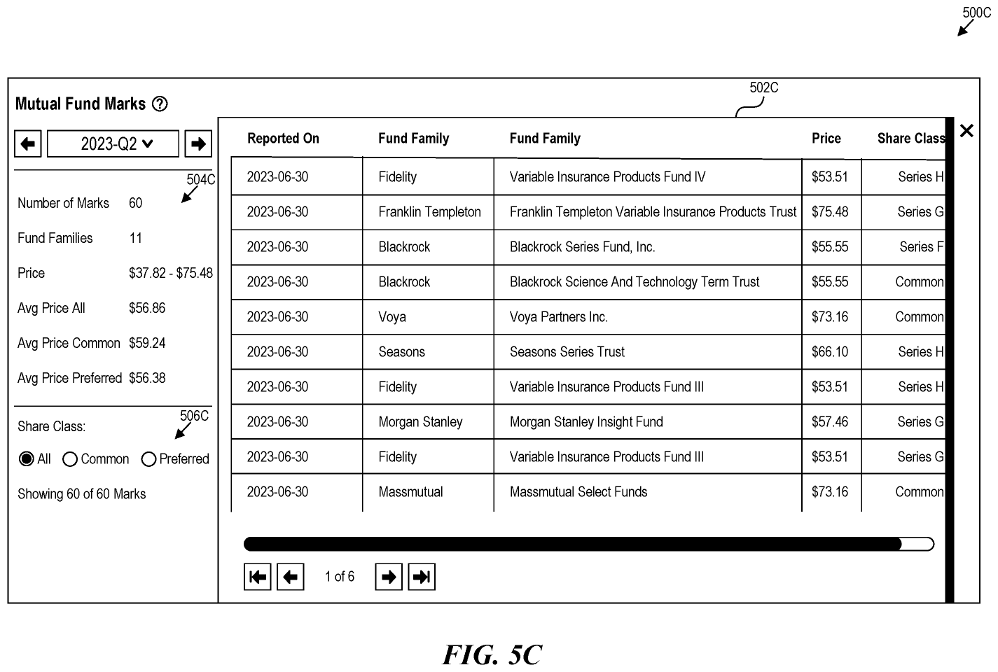

FIGS. 5A through 5C illustrate views of a user interface administered by the disclosed technology for subscribers of the platform. In particular, FIG. 5A illustrates a view 500A of a user interface that shows a price comparison for mutual fund marks. A subscriber can use this view to visualize a comparison of a fund price with another price indicator for a selected timeline. For example, the view 500A includes a graph 502A that plots a comparison between the average price reported for all funds and the funding round price over time. The price indicators can be selected in section 504A.

FIG. 5B illustrates a view 500B of the user interface presenting historical market data. The view includes a graph 502B that plots a comparison between the average price reported for all funds, the funding round price over time, and an average price reported by a selected fund for a particular issuer. In this example, a subscriber compares how Blackrock funds assign a price to a particular issuer with the price for all the other major funds (Fidelity, Franklin Templeton, etc.). The view 500B includes a section 504B that enables a subscriber to select a specific fund family and/or a fund for analysis, to present the analyzed data including an average of all its funds over a period in the graph 502B. A subscriber can drill down further to review data for a specific fund for each of the funds listed.

FIG. 5C illustrates a view 5000 of the user interface having a table that shows various mutual funds under analysis. The view includes a section 504C that presents price metrics for different funds at selected periods (e.g., “2023-Q2”). Subscribers can view more detailed information about a particular security via links to source filings in the table and select to view a section 506C including information for preferred and/or common securities.

### Computer System

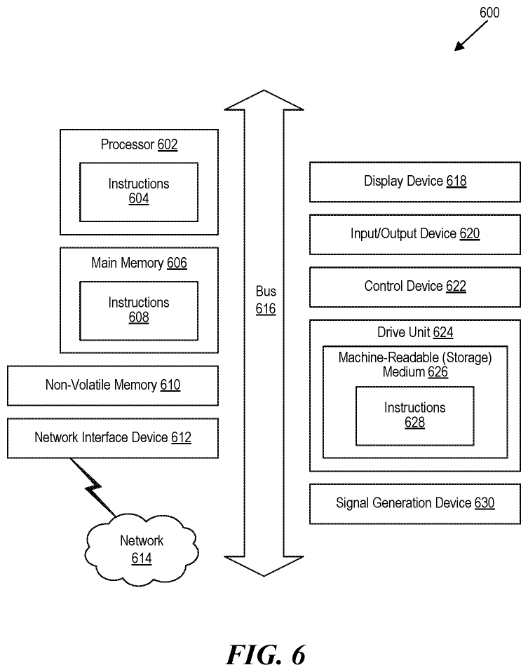

FIG. 6 is a block diagram that illustrates an example of a computer system 600 in which at least some operations described herein can be implemented. As shown, the computer system 600 can include: one or more processors 602, main memory 606, non-volatile memory 610, a network interface device 612, video display device 618, an input/output device 620, a control device 622 (e.g., keyboard and pointing device), a drive unit 624 that includes a storage medium 626, and a signal generation device 630 that are communicatively connected to a bus 616. The bus 616 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the figures and any other components described in this specification can be implemented.

The computer system 600 can take any suitable physical form. For example, the computing system 600 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 600. In some implementation, the computer system 600 can be an embedded computer system, a system-on-chip (SOC), a single-board computer system (SBC) or a distributed system such as a mesh of computer systems or include one or more cloud components in one or more networks. Where appropriate, one or more computer systems 600 can perform operations in real-time, near real-time, or in batch mode.

The network interface device 612 enables the computing system 600 to mediate data in a network 614 with an entity that is external to the computing system 600 through any communication protocol supported by the computing system 600 and the external entity. Examples of the network interface device 612 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 606, non-volatile memory 610, machine-readable medium 626) can be local, remote, or distributed. Although shown as a single medium, the machine-readable medium 626 can include multiple media (e.g., a centralized/distributed database and/or associated caches and servers) that store one or more sets of instructions 628. The machine-readable (storage) medium 626 can include any medium that is capable of storing, encoding, or carrying a set of instructions for execution by the computing system 600. The machine-readable medium 626 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 610, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 604, 608, 628) set at various times in various memory and storage devices in computing device(s). When read and executed by the processor 602, the instruction(s) cause the computing system 600 to perform operations to execute elements involving the various aspects of the disclosure.

### Remarks

The terms “example,” “embodiment,” and “implementation” are used interchangeably. For example, reference to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

I/We claim:

1. A method for discovering a value for a metric of an equity for a non-public entity, the method comprising:
ingesting non-standard datasets of reports disclosed by aggregators of combinations of equities for public and non-public entities,
wherein the non-standard datasets are streamed using an Application Programming Interface (API) from a public repository, and
wherein the reports include variable values for metrics of equities issued by public and non-public issuers and held by the aggregators;
extracting data items from the non-standard data based on one or more key identifiers of one or more aggregators and non-public issuers of equities,
wherein the data items include variable values for a particular metric of a particular equity of a particular non-public issuer;
executing a script that transforms the extracted data items into a standard format,
wherein the script includes libraries configured to read the extracted data items;
populating a data table with the transformed data items of the particular non-public issuer in the standard format;
spawning multiple computing jobs to process, in parallel, the transformed data items in the data table for the particular non-public issuer,
wherein each job encapsulates a script and executes a regex algorithm or a fuzzy logic algorithm configured to perform a string matching process to match data items of a common issuer in the data table; and
discovering, based on output of the multiple jobs, a value of a metric per equity for the particular non-public issuer.

2. The method of claim 1 further comprising:
causing an electronic device to present an actionable control element in association with the value of the metric per equity for the non-public entity,
wherein execution of the actionable control element causes communication of a message configured to initiate a transaction for one or more equity units of the non-public entity at the value per quantity unit.

3. The method of claim 1 further comprising, prior to spawning the multiple computing jobs:
selecting a particular key identifier for a particular aggregator that holds equity units for the particular non-public issuer or for the particular non-public issuer; and
adding the particular key identifier to a query configured to search a central index key (CIK) table for particular data items that match the particular key identifier,
wherein the particular data items are extracted using the query to search the CIK table.

4. The method of claim 1 further comprising:
detecting a new report published to the public repository including a key identifier that matches the one or more key identifiers of the one or more aggregators and the non-public issuers; and
updating the value of the metric per equity for the particular non-public issuer based on new data items extracted from the new report.

5. A method for predicting an equity metric of a target entity, the method comprising:
configuring a list to include a particular key for a fund portfolio issued by a particular management service of equity metrics for two types of entities,
wherein the two types of entities include a public entity and a non-public entity;
selecting the particular key for the particular fund portfolio to include in a query,
wherein the query is configured for input to a repository to search for reports matching the particular key;
monitoring the repository based on the query for a particular report generated by the particular management service having a key matching the particular key,
wherein the repository is configured to store multiple and distinct reports that were communicated over one or more computer networks from servers of the multiple management services,
wherein each report includes distinct value per quantity metrics for respective public entities, and
wherein each report includes equity metrics data for non-public entities but precludes a public value per quantity metrics for non-public entities;
retrieving a particular report for the particular fund portfolio having a timestamp subsequent to other reports stored at the repository for the fund portfolio;
populating a data table with equity metrics data of the non-public entities extracted from the particular report,
wherein the data table includes additional data for the non-public entities aggregated from additional reports for the particular fund portfolio and additional fund portfolios;
discovering target data of a target non-public entity in the data table based on fuzzy logic that matches similar but not identical entries indicative of the target non-public entity;
clearing security features from the target data of the target non-public entity in the data table;
predicting a value per quantity metric for the target non-public entity based on the target data of the target non-public entity having the security features cleared; and
causing an electronic device to present an actionable control element in association with the predicted value per quantity metric for the target non-public entity,
wherein execution of the actionable control element causes communication of a message configured to initiate a transaction for one or more equity units of the target non-public entity at the predicted value per quantity metric.

6. The method of claim 5, wherein configuring the list to include the particular key comprises:
selecting the particular key for the target non-public entity of interest;
collecting keys for one or more fund portfolios including equity data for the target non-public entity of interest,
wherein a script is executed to navigate between websites of management services that host the one or more fund portfolios;
comparing the collected keys with keys stored in a current list configured to monitor fund portfolios; and
adding the collected keys to the list of keys to monitor for reports for funds of interest.

7. The method of claim 5 further comprising:
recursively selecting a next key on the list of keys to monitor a next report for a next fund portfolio.

8. The method of claim 5:
wherein the equity metrics relate to equity shares of a public company or a non-public company,
wherein the equity metrics for any public company are public, and
wherein the equity metrics for any non-public company are private.

9. The method of claim 5:
wherein the equity metrics relate to equity shares of a public entity or a non-public entity.

10. The method of claim 5, wherein selecting the particular key to monitor the repository comprises:
configuring a query to include one or more keys to search the repository for one or more reports generated by one or more management services.

11. The method of claim 5:
wherein reports are communicated over the one or more computer networks from the multiple management services to the repository on a periodic basis, and
wherein only some of the reports communicated over the one or more computer networks are released publicly.

12. The method of claim 5, wherein multiple reports each include total equity values for the target non-public entity held by management services, and wherein predicting the value per quantity metric for the target non-public entity comprises:
processing the equity metrics data of the target non-public entity with a machine-learned engine that is generated and trained based on reports including data of non-public entities; and
outputting the predicted value per quantity metric of the target non-public entity as an output of the machine-learned engine.

13. The method of claim 5, wherein predicting the value per quantity metric for the target non-public entity comprises:
determining a total value held in a fund portfolio for the target non-public entity; and
predicting a total unit value for the target non-public entity held in the fund portfolio,
wherein the predicted value per quantity metric is estimated by dividing the total value by the total unit value.

14. The method of claim 5, wherein retrieving the particular report comprises:
comparing timestamps of multiple reports for the particular fund portfolio relative to a current time; and
identifying, based on the comparison, a most recent report as the particular report for the particular fund portfolio.

15. The method of claim 5, wherein populating the data table with data of the non-public entities extracted from the particular report comprises:
generating an xml file; and
populating the xml file with entries for the data of the non-public entities.

16. The method of claim 5, wherein the data table includes data for the public entities aggregated from reports in addition to the data from the non-public entities.

17. The method of claim 5, wherein discovering the target data of the target non-public entity based on fuzzy logic comprises:
matching text in the data table based on the particular key,
wherein the particular key is for the particular non-public entity.

18. The method of claim 5, wherein clearing the security features comprises:
performing text and pattern recognition to determine a security type and remove unnecessary information from the target data of the target non-public entity.

19. The method of claim 5 further comprises:
derive additional analytics that provide insights of the target non-public entity.

20. The method of claim 5, wherein discovering the target data of the target non-public entity in the data table based on fuzzy logic comprises:
comparing a key for the target non-public entity to keys in the data table.

21. A non-transitory computer-readable storage medium storing instructions, which, when executed by at least one data processor of a system, cause the system to:
monitor a centralized repository for a report having a particular key matching a particular fund portfolio,
wherein the centralized repository stores reports generated by multiple management services of equity metrics for two types of entities, and
wherein each report includes value per quantity metrics for a first type of entity but not for a second type of entity;
retrieve a particular report for the particular fund portfolio,
wherein the particular report is a most recent report among other reports stored at the centralized repository for the particular fund portfolio;
generate a data table including equity metrics data for the first type of entities extracted from the particular report,
wherein the data table is aggregated to include additional data for the first type of entity extracted from additional reports collected periodically from the central repository;
identify target data of a target entity in the data table based on a machine-learned engine,
wherein the target entity is a first type of entity;
predict a value per quantity metric for the target entity based on the target data; and
causing an electronic device to present the predicted value per quantity metric for the target entity.

22. The non-transitory computer-readable storage medium of claim 21, wherein to monitor the centralized repository comprises causing the system to:
configure a list to include a key for a respective fund portfolio of equity metrics for two types of entities; and
recursively select keys from the list to monitor fund portfolios.

23. The non-transitory computer-readable storage medium of claim 21, wherein the two types of entities include public companies and private companies, the system being further caused to:
cause a display device to present a graphical element configured for causing execution of a transaction with a private company based on the predicted value per quantity metric for the private company.

24. A server system comprising:
at least one hardware processor; and
at least one non-transitory memory storing instructions, which, when executed by the at least one hardware processor, cause the system to:
monitor a centralized repository for a data file including a key for a particular fund portfolio,
wherein the centralized repository stores multiple data files generated by multiple management services of equity metrics, and
wherein each report includes value per quantity metrics for a first type of entity but not for a second type of entity;
retrieve a particular report for the particular fund portfolio,
wherein the particular report is a most recent report among reports stored at the centralized repository for the particular fund portfolio;
aggregate equity metrics data for the first type of entities extracted from the particular report into data table sets including additional data for the first type of entities;
identify target data of a target entity in the data table sets,
wherein the target entity is a first type of entity; and
derive a value per quantity metric for the target entity based on the target data.
